(19) United States
(12) Patent Application Publication
(10) Pub. No.: US 2010/0133982 A1
(43) Pub. Date: Jun. 3, 2010

(54) LAMP, LAMP HOLDER, AND ASSEMBLY OF SUCH A LAMP AND SUCH A LAMP HOLDER

(75) Inventors: Mathew L. Bembridge, Eindhoven (NL); Eckhardt H.M. Schraven, Eindhoven (NL); Markus Pieper, Arnsberg (DE); Karl-Wilhelm Vogt, Arnsberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/525,910

(22) PCT Filed: Feb. 8, 2008
(86) PCT No.: PCT/IB2008/050455

§ 371 Date: Feb. 2, 2010

(30) Foreign Application Priority Data
Feb. 12, 2007 (EP) 07102174.5

(51) Int. Cl. H01J 5/50

(52) U.S. Cl. 313/318.01

(57) ABSTRACT

The invention relates to an assembly of a lamp and a lamp holder. The invention also relates' to a lamp' for use in an assembly of a lamp and a lamp holder. The invention further relates to a lamp holder for use in an assembly of a lamp and a lamp holder. Assembly of a lamp (2) and a lamp holder (3), said lamp comprising at least one light-transmissive vessel (4) being sealed at one single end by a lamp base (5), said lamp base (5) being provided with a substantially annular flange enclosing an accommodating space for multiple current-supply conductors (6) connected to said vesel (4), wherein the annular flange is provided with coupling means (7), said lamp holder (3) comprising at least one protruding portion (10) being provided with counter-coupling means (14), and electrical contact members (13) adapted to be electrically connected to the current-supply conductors (6) of the lamp (2), wherein the protruding-portion (10) of the lamp holder (3) is adapted to engage the annular flange of the lamp (2) for allowing, the coupling means (7) of the lamp to cooperate with the counter-coupling, means (14) of the lamp holder (3) in a predefined mutual orientation of the lamp (2) and the lamp holder (3).

### FIELD OF THE INVENTION

The invention relates to an assembly of a lamp and a lamp holder. The invention also relates to a lamp for use in such an assembly. The invention further relates to a lamp holder for use in such an assembly.

### BACKGROUND OF THE INVENTION

Fluorescent lighting technology has been available for over 50 years and has been gradually supplanting conventional light bulbs, also known as incandescent bulbs, owing to their huge energy saving and four to six times higher efficiency to produce the same lumens as compared to the incandescent lamp. Compact fluorescent lamps (CFL) typically have a standardised lamp base acting as interface to connect the lamp to a lamp holder. The existing lamp base is relatively voluminous, in particular relatively long, which is detrimental to the optical efficiency of a luminaire surrounding the connected lamp. Moreover, since the known lamp base has a rectangular cross-section, connection of the lamp to a lamp holder will commonly be complex as two connection possibilities will be available for a user, while commonly merely a single orientation of the lamp with respect to the lamp holder will lead to a proper position of said lamp with respect to said lamp holder, and in particular of the electrodes of both the lamp and the lamp holder. Hence, there is a need to simplify proper installation of a lamp, in particular of a CFL, into a lamp holder.

It is an object of the invention to provide an improved assembly of a lamp and a lamp holder, wherein said lamp and said lamp holder can be connected to each other in a relatively user-friendly manner.

### SUMMARY OF THE INVENTION

This object can be achieved by providing an assembly according to the preamble, said lamp comprising at least one light-transmissive vessel being sealed at one single end by a lamp base, said lamp base being provided with a substantially annular flange enclosing an accommodating space for multiple current-supply conductors connected to said vessel, the annular flange being provided with coupling means, said lamp holder comprising at least one protruding portion being provided with counter-coupling means, and electrical contact members adapted to be electrically connected to the current-supply conductors of the lamp, the protruding portion of the lamp holder being adapted to engage the annular flange of the lamp for allowing the coupling means of the lamp to cooperate with the counter-coupling means of the lamp holder in a predefined mutual orientation of the lamp and the lamp holder. By applying an annular flange having a circularly-cylindrical shape (ring-shape), a rotational sliding engagement of the annular flange and the protruding portion will be allowed to position the lamp in the predefined orientation with respect to the lamp holder, which will facilitate installation of the lamp in a substantial manner. An inner surface and/or an outer surface of the annular flange will act as sliding surface for at least a part of the protruding portion during mutual displacement (rotation) of the lamp and the lamp holder. During engagement of the annular flange to the protruding portion, the lamp may be rotated along its longitudinal axis until the (at least one) predefined orientation of the lamp with respect to the lamp holder is obtained in which the coupling means and the counter-coupling means will be able to cooperate, leading to a proper coupling of the lamp to the lamp holder. Hence, by simply positioning the lamp base, in particular the flange, against the protruding portion of the lamp holder, and (in case the lamp has not yet been positioned in the predefined orientation) by subsequently axially rotating the lamp to the predefined orientation, a connection between the lamp and the lamp holder may be established. Since the lamp base provided with the annular flange, and the protruding portion may be constructed in a relatively compact manner, a relatively compact construction of the assembly may be achieved, which will enhance the optical efficiency of a (less open) luminaire in which the lamp holder may be incorporated. The exposed parts of the current-supply conductors are preferably fully positioned within the accommodating space defined by the flange to prevent or at least counteract damaging of the current-supply conductors.

In a preferred embodiment, the coupling means and the counter-coupling means are adapted to realise a coupling between the lamp and the lamp holder by (commonly linearly) translating the lamp with respect to the lamp holder along a longitudinal axis of the lamp followed by axially rotating the lamp. In this manner a solid and durable connection between the lamp and the lamp holder can be established in a relatively efficient manner. More in particular, the coupling means and the counter-coupling means together form at least one bayonet fitting, in which a translational and subsequent rotational movement have been incorporated. To improve the stability of the connection between the lamp and the lamp holder, the coupling means and the counter-coupling means together preferably form multiple bayonet fittings, in particular at least five bayonet fittings. It has been shown that the application of five (or more) bayonet fittings will facilitate locating the predefined orientation of the lamp, and hence will relatively easily lead to a relatively durable connection between the lamp and the lamp holder, such that a reliable contact between the current-supply conductors and the electrical contact members can be secured.

The coupling means preferably comprises multiple coupling elements being applied to the annular flange according to an at least partially irregular coupling means pattern. Thus, the coupling elements are distributed irregularly over the annular flange to define the orientation of the lamp in which the lamp can be connected to the lamp holder. Hence, the pattern of the positioning of the coupling elements provides in fact a locating means defining how to connect the lamp to the lamp holder. The counter-coupling means preferably comprises multiple counter-coupling elements being applied to the protruding portion according to a counter-coupling means pattern corresponding to the coupling means pattern. The number of coupling elements and counter-coupling elements may differ, but are preferably equal. In a particular preferred embodiment, the counter-coupling means comprises multiple cams (or projections), and the coupling means comprises multiple slots for receiving said cams. By applying slots and cams, a bayonet fitting may easily be realised. However, also kinds of fittings other than bayonet fittings, such as e.g. a snap fitting, may be used to connect the lamp to the lamp holder. In an alternative and opposite embodiment, the coupling means comprises multiple cams (or projections), and the counter-coupling means comprises multiple slots for receiving said cams.

The protruding portion will commonly be in sliding contact with the annular flange in case of axial rotation of the lamp during installation of the lamp. The shape and dimensioning of the protruding portion can be very arbitrary. Preferably, the protruding portion comprises a protruding (cup-shaped) collar adapted to enclose the annular flange at least partially after installation of the lamp. According to this embodiment, the protruding collar of the lamp holder will be adapted to receive, and hence shield, the annular flange. According to the embodiment, the coupling means of the flange will commonly be positioned at an outer surface of the flange, while the counter-coupling means of the protruding collar will commonly be positioned at an inner surface of the collar to be able to establish a connection between the lamp and the lamp holder. In another embodiment, the protruding portion may (possibly in addition to the protruding collar) comprise a central protruding portion, which is preferably cylindrically shaped, in which case the accommodating space defined by the annular flange is adapted to receive said central protruding portion at least partially. According to this latter embodiment, an inner surface of the annular flange of the lamp is preferably adapted to engage an outer surface of the protruding portion of the lamp holder. More preferably, an inner surface of the annular flange is provided with the coupling means, while an outer surface of the central protruding portion is provided with the counter-coupling means.

The annular flange may be integrated with the lamp base. However, in a preferred embodiment the annular flange is formed by a separate element being coupled, more preferably releasably coupled, to the lamp base. An advantage of applying a separate annular flange is that the annular flange preferably displays information related to at least one lamp characteristic, as a result of which a standard and simple lamp base can be manufactured after which the lamp-identifying flange is applied to the lamp base, which will commonly be advantageous from both a logistic and a financial point of view. The lamp characteristic can be exhibited by colour differentiation of the flange. It is also possible to display characteristic (technical) information onto the flange to indicate one or more lamp characteristics.

In the assembly according to the invention, multiple types of lamps may be applied. However, preferably, a discharge lamp, more particularly a compact fluorescent lamp (CFL), is applied in the assembly according to the invention. Advantages of the CFLs are generally known.

The invention also relates to a lamp for use in an assembly according to the invention, said lamp comprising at least one light-transmissive vessel being sealed at one (single) end by a lamp base, said lamp base being provided with a substantially annular flange enclosing an accommodating space for multiple current-supply conductors connected to said vessel, the annular flange being provided with coupling means, and said annular flange of the lamp being adapted to engage a protruding portion of a lamp holder for allowing said coupling means of the lamp to cooperate with the counter-coupling means of the lamp holder in a predefined mutual orientation of the lamp and the lamp holder.

The invention also relates to a lamp holder for use in an assembly according to the invention, said lamp holder comprising at least one protruding portion being provided with counter-coupling means, and contact members adapted to be electrically connected to current-supply conductors of a lamp, said protruding portion of the lamp holder being adapted to engage an annular flange of the lamp for allowing coupling means of the lamp to cooperate with the counter-coupling means of the lamp holder in a predefined mutual orientation of the lamp and the lamp holder. Advantages and preferred embodiments of both the lamp and the lamp holder have already been described above in a comprehensive manner.

### BRIEF DESCRIPTION OF THE DRAWINGS

The invention is illustrated by way of the following non-limitative examples, wherein:

FIG. 1 shows a perspective view of a first embodiment of an assembly of a lamp and a lamp holder according to the invention,

FIG. 2 shows a perspective view of a second embodiment of an assembly of a lamp and a lamp holder according to the invention, and

FIGS. 3a-3c show comparative sketches comparing a known lamp and a lamp according to the invention.

### DETAILED DESCRIPTION OF THE EMBODIMENTS

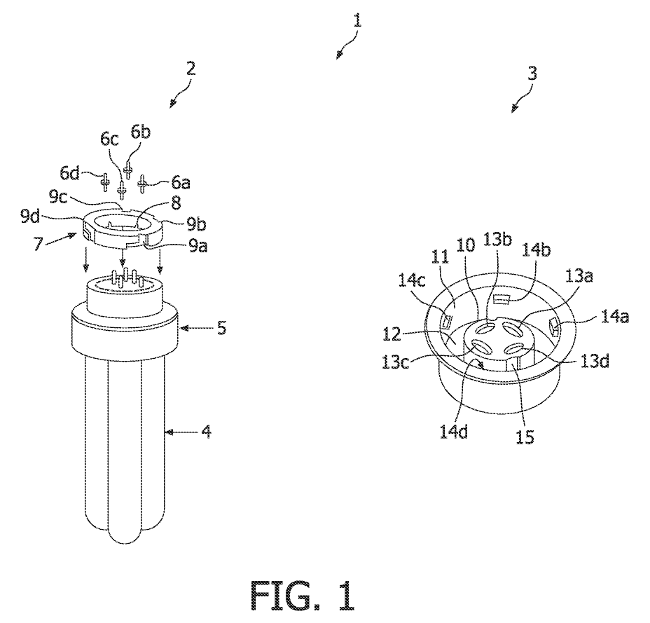

FIG. 1 shows a perspective view of a first embodiment of an assembly 1 of a lamp 2 and a lamp holder 3 according to the invention. In this illustrative embodiment the lamp 2 is a compact fluorescent lamp (CFL) comprising a discharge vessel 4. The vessel 4 is sealed at one end by a lamp base 5. The lamp base 5 comprises four current-supply conductors 6a, 6b, 6c, 6d. The lamp 2 further comprises a coupling ring 7 which is attached to the lamp base 5 such that the current-supply conductors 6a, 6b, 6c, 6d are positioned within an accomodating space 8 defined within the ring 7. The ring 7 can have a particular colour indicating the type of lamp and/or the consuming power of the lamp 2. An outer surface of the ring 7 is provided with multiple angular slots 9a, 9b, 9c, 9d. The lamp 2 is adapted to be connected with the lamp holder 3. The lamp holder 3 comprises a central protruding portion 10 and a protruding collar 11 surrounding the central protruding portion 10. Between the central protruding portion 10 and the protruding collar 11 a receiving space 12 is accommodated for receiving the ring 7 of the lamp 2. The central protruding portion 10 is provided with connection slots 13a, 13b, 13c, 13d to electrically connect the lamp 2 with the lamp holder 3. The protruding collar 11 is provided with multiple cams 14a, 14b, 14c, 14d which can be inserted in the slots 9a, 9b, 9c, 9d. Hence, the assembly 1 comprises multiple bayonet fittings. In case of installation of the lamp 2, the lamp 2 is positioned against the lamp holder 3, whereby in particular the ring 7 engages the cams 14a, 14b, 14c, 14d and possibly also the central protruding portion 10 and/or the protruding collar 11. By axially rotating the lamp 2 with respect to the lamp holder 3, the lamp 2 can be brought in a predefined orientation, wherein the cams 14a, 14b, 14c, 14d of the lamp holder 3 can be inserted in the slots 9a, 9b, 9c, 9d to establish a solid and stable connection between the lamp 2 and the lamp holder 3. Optionally the central protruding portion 10 is provided with a mechanical lamp key 15 adapted to cooperate with a counter key (not shown) forming part of the ring 7 to secure that the right type of lamp 2 is inserted in the right type of lamp holder 3.

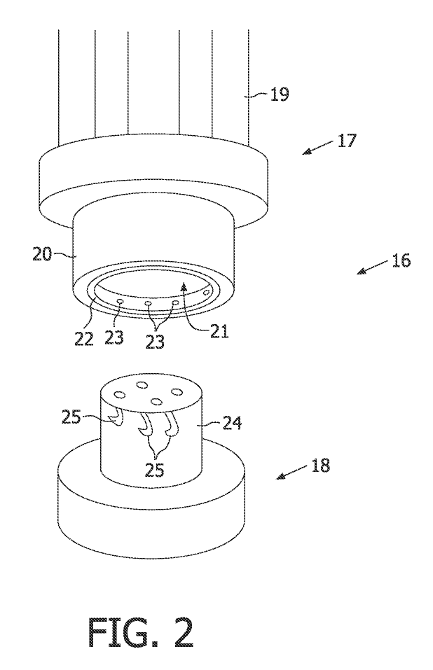

FIG. 2 shows a perspective view of a second embodiment of an assembly 16 of a lamp 17 and a lamp holder 18 according to the invention. The lamp 17 comprises a light-transmissive vessel 19 and a lamp base 20. The lamp base 20 is provided with a receiving space 21 in which a connection ring 22 is applied, such that an outer surface of the connection ring 22 is attached to an inner surface of the lamp base 20. An inner side of the connection ring 22 is provided with projecting coupling elements 23. The lamp holder 18 comprises a protruding structure 24, which is adapted to be received in a tight-fitting manner by the receiving space 21 of the lamp 17. The protruding structure 24 is provided with multiple hooked slots 25 adapted for receiving the projecting coupling elements 23 for simultaneously realising multiple bayonet fittings between the lamp 17 and the lamp holder 18.

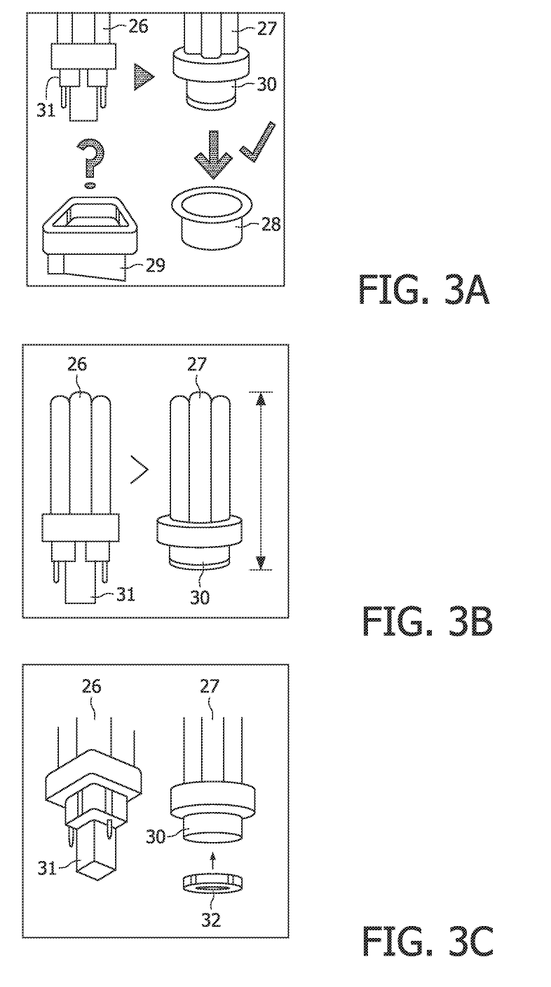

FIGS. 3a-3c show comparative sketches comparing a known lamp 26 and a lamp 27 according to the invention. FIG. 3a shows the user-friendliness of the lamp 27 according to the invention: the lamp 27 can be brought into initial contact with a lamp holder 28 in any orientation of the lamp 27, after which the lamp 27 can be rotated to find the predefined connecting orientation. The known lamp 26 can be inserted into a lamp holder 29 in four manners, while only one orientation will lead to a proper connection of the lamp 26 to the lamp holder 29. FIG. 3b shows that a lamp base 30 of the lamp 27 is relatively compact compared to the relatively voluminous lamp base 31 of the known lamp 26. Moreover, in FIG. 3c is shown that the lamp base 30 of the lamp 27 according to the invention has a relatively simple construction compared to the lamp base 31 of the lamp 26 known from the prior art. Hence, manufacturing of the lamp base 30 of the improved lamp 27 requires a relatively simple mould, while the known lamp base 31 requires a more complex mould, and hence a relatively difficult production process. A ring 32 attached to the improved lamp base 30, said ring 32 being adapted to couple the lamp 27 to the lamp holder 28, will commonly be manufactured separately.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage

1. Assembly of a lamp and a lamp holder, said lamp comprising at least one light-transmissive vessel being sealed at one single end by a lamp base, said lamp base having a substantially annular flange enclosing an accommodating space for multiple current-supply conductors connected to said vessel, wherein the annular flange comprising first coupling means, said lamp holder comprising at least one protruding portion being comprising second coupling means, and electrical contact members adapted to be electrically connected to the current-supply conductors of the lamp, wherein the protruding portion of the lamp holder is adapted to engage the annular flange of the lamp for allowing the first coupling means to cooperate with the second coupling means in a predefined mutual orientation of the lamp and the lamp holder.

2. Assembly according to claim 1, wherein the first and second coupling means are configured to facilitate a coupling between the lamp and the lamp holder by translating the lamp with respect to the lamp holder along a longitudinal axis of the lamp followed by axially rotating the lamp.

3. Assembly according to claim 2, wherein the first and second coupling means together form at least one bayonet-type fitting.

4-5. (canceled)

6. Assembly according to claim 5, wherein the second coupling means comprises multiple elements for engaging the protruding portion.

7. Assembly according to claim 1, wherein the second coupling means comprises multiple cams, and that the first coupling means comprises multiple slots for receiving said cams.

8. Assembly according to claim 1, wherein the protruding portion comprises a protruding collar adapted to enclose the annular flange at least partially.

9. Assembly according to claim 8, wherein an outer surface of the annular flange of the lamp is adapted to engage an inner surface of the protruding portion of the lamp holder.

10. Assembly according to claim 1, wherein the accommodating space enclosed by the annular flange is adapted for receiving the protruding portion at least partially.

11. Assembly according to claim 10, wherein t an inner surface of the annular flange of the lamp is adapted to engage an outer surface of the protruding portion of the lamp holder.

12. Assembly according to claim 1, wherein the annular flange is releasably coupled to the lamp base.

13. Assembly according to claim 1 wherein the annular flange displays information related to at least one lamp characteristic.

14. Assembly according to claim 1, wherein the lamp is a discharge lamp.

15-16. (canceled)
